(19) United States
(12) Patent Application Publication
(10) Pub. No.: US 2009/0132561 A1
(43) Pub. Date: May 21, 2009

(54) LINK-BASED CLASSIFICATION OF GRAPH NODES

(75) Inventors: Graham Cormode, Summit, NJ (US); Smriti Bhagat, Highland Park, NJ (US); Irina Rozenbaum, Piscataway, NJ (US)

Correspondence Address: AT&T Legal Department - HB;Patent Docketing, One AT&T Way, Room 2A-207, Bedminster, NJ, 07921, US

(73) Assignee: AT&T LABS, INC., Austin, TX (US)

(21) Appl. No.: 11/943,681

(22) Filed: Nov. 21, 2007

(51) Int. Cl. G06F 17/30

(52) U.S. Cl. 707/100; 707/E17.089

(57) ABSTRACT

A method of labeling unlabeled nodes in a graph that represents objects that have an explicit structure between them. A computing device can use a labeling engine to labeled nodes in a graph that are labeled and can identify an unlabeled node in the graph that is structurally associated with the labeled nodes. The labeling engine can label the unlabeled node with the label of the labeled node based on the structural association between the unlabeled node and the labeled node.

### BACKGROUND OF THE INVENTION

1. Field of the invention

The present invention is directed to classifying objects based on an underlying graph structure, and more specifically, to labeling nodes of the underlying graph structure based on edges between the nodes.

2. Brief Description of the Related Art

Classifying objects, such as text documents, images, web pages, or customers, and inferring some grouping among the objects is a fundamental problem. Groupings generally use a structure that is inherent amongst the objects. For example, in classifying text documents, two texts that share word(s) may be considered related. More generally, there is an underlying graph (in some cases, hierarchical) structure amongst the objects based on the features that define them. The similarity distances between the objects may satisfy additional metric properties, such as a triangle inequality. Inferring such structure and classifying objects is a problem.

In applications, such as analyzing social networks or communication networks, an explicit graph structure among the objects exists. For example, in classifying blogs, each blog has links to other blogs, either via postings, comments, or content. In classifying IP addresses, each IP address links to other IP addresses via packets sent or received. In these applications, as well as others, there may be no transitivity in the structure. Additionally, there may not be any metric property associated with the similarity of pairs of such objects.

Classification of objects has been studied in various domains. However, the scenario where the objects in a domain, such as the world wide web, IP networks, or e-mail networks, which have an explicit link structure associated amongst them, has been less thoroughly studied.

One example of classification is ranking in networks. However, ranking is quite different from the problem of labeling. Ranking attempts to places a numeric ordering over the nodes, while labeling attempts to attach a categorical label to nodes that describe one or more attributes or features of the node.

Another example is the classification of web pages using text features. For instance, text categorization has been performed using Support Vector Machine (SVM) learning. Further, Latent Semantic Indexing, which uses eigenvector computation to classify web pages, has been used. As still another example, text from neighboring web pages has been used to develop statistical models for labeling web pages in a supervised setting. However, such text-based approaches cannot apply to classification based solely on the neighborhood information from the associated link structure because the text-based approach requires an evaluation of the textual content of an object.

Recently, work has been performed in graph-based semi-supervised learning. However, this work is defined for a binary classification problem, therefore does not apply to the case where there are multiple classes. Moreover, the binary classification assumes that each edge weight precisely represents the similarity between the corresponding pair of nodes.

### SUMMARY OF THE INVENTION

The present invention enables labeling unlabeled nodes in a graph structure using a structural association between the unlabeled nodes and labeled nodes. The labeling can be implemented using local iterative and/or global nearest neighbor approaches. The labels are preferably chosen from a predetermined set of labels. The labels available can depend on the application

In one embodiment, a method of determining information associated with an object represented as a node in a graph is disclosed. The method includes associating a label of at least one labeled node with an unlabeled node based on a structural association between the unlabeled node and the labeled node.

In another embodiment, a computer-readable medium that includes instructions executable by a computing device for determining information associated with an object represented as a node in a graph is disclosed. The instructions determine information by associating a label of at least one labeled node with an unlabeled node based on a structural association between the unlabeled node and the labeled node.

In a further embodiment, a system for determining information associated with an object represented as a node in a graph is disclosed. The system includes computing device that associates a label of at least one labeled node with at least one unlabeled node based on the structural association between the unlabeled node and the labeled node.

Other objects and features of the present invention will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIG. 1A shows a graph structure that corresponds to a group of interrelated objects having an inherent structure;

FIG. 1B shows an adjacency matrix for the graph structure shown in FIG. 1A;

FIG. 2 shows a portion of a graph structure that represents objects as nodes and the associations between objects as edges to illustrate the local iterative approach;

FIG. 3 is a flow diagram showing a preferred embodiment of the local iterative approach;

FIGS. 4A-B are a flow diagram showing the local iterative approach in more detail;

FIG. 5 shows a portion of a graph structure with different types of nodes that represent different types of objects having an inherent structure to illustrate another aspect of the local iterative approach;

FIG. 6 shows a portion of a graph structure that represents objects as nodes and the associations between the objects as edges to illustrate the global nearest neighbor approach;

FIG. 7 is a flow diagram showing a preferred embodiment of the global nearest neighbor approach in accordance with the present invention;

FIG. 8 is a flow diagram showing the global nearest neighbor approach in more detail;

FIG. 9 shows a portion of a graph structure that includes different types of nodes;

FIG. 10 shows a computing device for implementing the labeling of unlabeled nodes in a graph structure using the local iterative and/or global nearest neighbor algorithms;

FIGS. 11A-B show results of experiments using the local iterative approach and the global nearest neighbor approach in accordance with the preferred embodiments;

FIG. 12 shows results of experiments that allow propagation of labels via pseudo-labels; and

FIGS. 13A-B show that the performance of the local iterative and global nearest neighbor approaches does not change significantly when there is a small percentage of labeled nodes.

### DETAILED DESCRIPTION OF THE PREFERRED EMBODIMENTS

In preferred embodiments of the present invention, classification labels can be inferred for objects that have an explicit structure between them. Such objects can be naturally modeled as nodes of a graph, such as a directed multigraph, with edges forming the explicit structure between nodes. A multigraph, as used herein, refers to a graph where there can be more than one edge between two nodes and there can be different kinds of nodes. The preferred embodiments of the present invention are directed to labeling unlabeled nodes based on the explicit structure formed by the edges. As a result, the preferred embodiments apply uniformly to all applications. In the case where additional features are available, the additional features can be used to improve the results of the classifications performed. The preferred embodiments can be scaled for large input sizes and can be implemented using (semi-)supervised learning so that classification labels on nodes are inferred from those of a given subset of labels.

The preferred embodiment can implement local iterative and/or global nearest neighbor algorithms to label nodes having unknown labels using a structural association between the nodes of the graph. A structural association, as used herein, refers to interconnections between nodes via edges. For example, a structural association between two nodes can be an edge connecting the two nodes and/or a structural association can be a pattern formed by connections between nodes edges in a selected region of the graph. The labels are preferably chosen from a predetermined set of labels

The labels depend on the application. For example, if the objects were telephone numbers or Instant Messaging IDs and there are explicit calls or messages between pairs of objects, some of the labels for the objects may be business/individual, fraudulent or otherwise, and the like. If the objects were IP addresses, labels may be server/client. Similarly, if the objects were blogs, then one may be interested in inferring metadata about the blogs, such as the age associated with the blog as well as others.

Although the preferred embodiments do not require other features associated with the objects apart from their structural association, some features besides the structural association between the objects may be used. For example in analyzing blogs, one may be able to use the content words in the blog postings. In IP networks, one may be able to look at the bits sent between addresses.

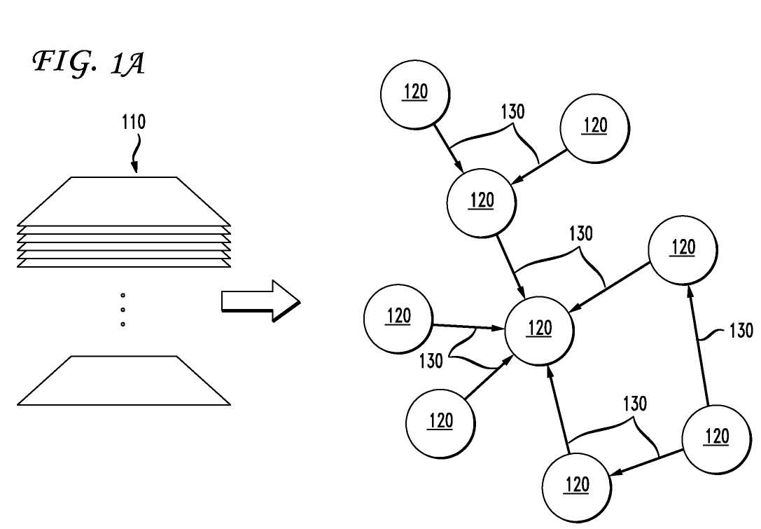

FIG. 1A shows a graph structure 100 that corresponds to a group of interrelated objects 110, such as web pages, blogs, customers, telephone calls, documents, and the like. None, some, or all of the objects 110 in the group can be of a single type, such as blogs, or the objects may include multiple types, such as blogs and web pages. The objects 110 can have an inherent structure such that each object may be associated with one or more other objects in the graph 100. Each node 120 in the graph can represent one of the objects 110. The edges 130 between the nodes 120 can represent a structural association between the objects 110. Thus, the objects 110 can be represented by a structured graph of nodes and edges. One or more of the nodes may have an assigned or known label, while other nodes may have an unassigned or unknown label. Using the structural associations between the nodes, the preferred embodiments can assign a label to the unassigned or unknown nodes. Mathematically, this can be defined as follows:
DEFINITION 1. Let G be a partially labeled graph G=(V,E,M), where V is the set of nodes, E is the set of edges, and M is the labeling function. Let L={l₁, l₂, . . . , l_{c}} be the set of labels, where a label lₖ can take an integer or a nominal value, and c=[|L| is the number of possible labels. M:V→L∪ {0{ is a function which gives the label for a subset of nodes W⊂ V; for nodes v ε W, M(v)=0, indicating that v is initially unlabeled. Given the partially labeled graph G, the goal is to complete the labeling: by assigning labels to nodes in U=V/W.

Some node types may have more or less information than other node types. This is a result of how much can be sampled or observed in the domain(s) of interests. For example, in the telecommunications domain, service providers can observe both incoming and outgoing calls for their customers, but cannot observe calls between customers of other providers. As a result, the graph a provider sees may not contain all the outgoing/incoming edges of some of the nodes. Likewise in blog or web analysis, the outgoing edges for each page may be known, but some of the incoming edges may be unknown because it is typically infeasible to collect all blog and web data. As result of this limited observability and collectability, the graph may not include all information.

The objects 110, and therefore the graph 100 of FIG. 1A can represent, for example, telephone calls, a distinct IP address, a segment of IP addresses, an Internet Service Provider (ISP) network, web pages, etc. As one example, with reference to telephone calls, the nodes 120 can represent distinct phone numbers and the edges 130 can represent telephone calls made between two phone numbers. Some nodes can represent 1-800 numbers that can only receive calls, while other nodes 120 can represent consumer accounts. There can be multiple edges 130 between nodes and multiple kinds of edges, such as edges that represent long distance calls, local calls, and toll free calls. A suitable label in this example is a classification by business/non-business phone numbers. Typically, telephone companies have a business directory to populate labels on a subset of nodes, and in some cases, use human evaluation to label some nodes.

As another example, with reference to an IP network setting, a node 120 in the graph 100 can represent an ISP network and one of the edges 130 between two nodes 120 can represent IP traffic detected between the two nodes. The IP traffic can be for example, traffic belonging to a certain application or protocol, certain types of messages, etc. A suitable label in this case is based on the network node's function as a server or a client. Typically ISPs have a list of known or suspected servers which is the initial set of labels from which the classification of server/client for remaining nodes can be inferred.

As another example, with reference to the World Wide Web, the nodes 120 can represent web pages, which can be further categorized by ownership, functionality, or topic. Edge(s) 130 between the nodes 120 can signify an HTML link from one web page to another. The edges 130 can be categorized. For example, a link from a site to a commercial company website can signify, that the company's advertisement is present on the website. In this setting, suitable node labels can be based on the site being public or commercial, or the site's function (portal, news, encyclopedia, etc). Again, suitable lists of labels on subsets of nodes are known, so unassigned or unknown labels can be inferred for the remainder of the nodes.

The local iterative and global nearest neighbor approaches implemented in accordance with the preferred embodiments can take, as an input, a description of a graph, such as a directed multi-graph, as well as any features and labels associated with the graph. Since the graph structure representation of objects can be very large in size, the graphs can be described in the form of an adjacency list, adjacency matrix, or similar set of edges. For convenience, the graphs are described in adjacency matrix notation as follows.
Let A be an n×n adjacency matrix representing a graph G=(V,E), where V is the set of nodes and E is the set of edges and where aᵢⱼ=1 if (i,j) ε E and is 0 otherwise (more generally, aᵢⱼ can be a weight of an edge from i to j if any); n=|V| is the number of nodes. Let A₍ᵢ₎ denote the i^{th} row of matrix A and A^{(j)} denote the j column of A, where i,j ε [1,n]. The notation diag(f) on a function f is shorthand for the dom(t)×dom(f) matrix such that diag(f)_{i,i}=f(i), and is zero elsewhere.

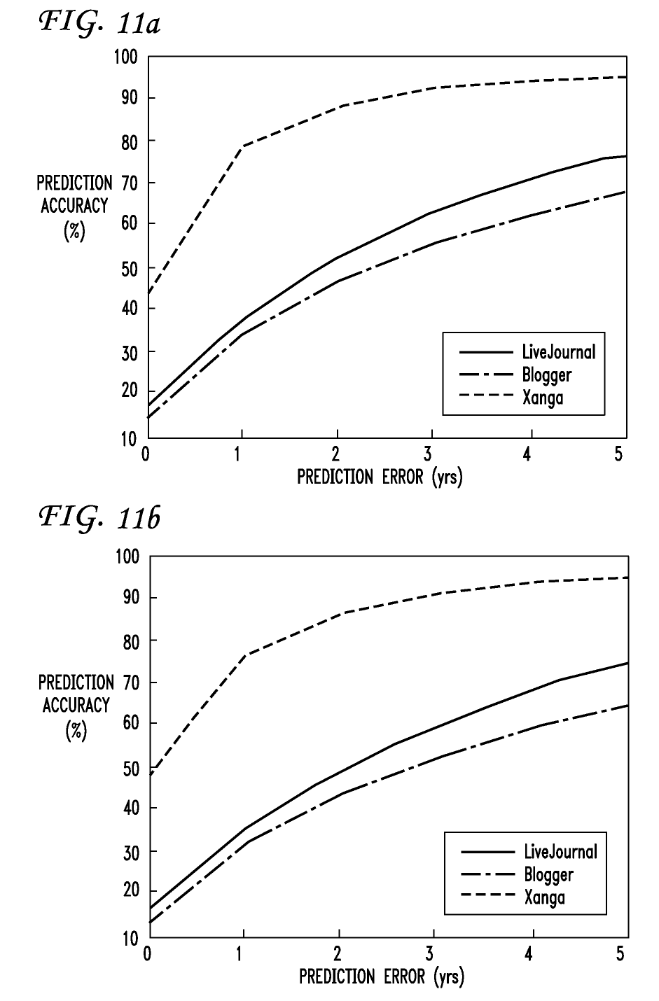

FIG. 11B shows an adjacency matrix that corresponds to the graph structure 100. The rows 150 represents nodes i such that the nine nodes of graph 100 are represented. The columns 160 represents nodes j, which are the same as nodes i such that the nine nodes of graph structure 100 are represented. A zero in the matrix indicates that there is no directed edge from a node j to a node i and a one indicates that there is a directed edge from a node j to a node i. For example, the zero at position i=1 and j=1 indicates that there is no edge on node one that loops onto itself, the zero at position i=1 and i=2 indicates that there is no edge from node two to node one, and the one at position i=3 and j=1 indicates that there is an edge from node one to node 3.

The neighborhood of each node i, defined by the immediately adjacent nodes, is encoded as a feature vector, B(i), based on the link structure of node i (in general, however, the feature vector could also include other features of the node). The feature vector is a vector that contains elements that represent the possible labels a node can be assigned. This feature vector preferably represents the frequency of the labels on nodes in the neighborhood of the node to be labeled. From these vectors, we create an n×c feature matrix B, whether c is the number of possible labels. Given a function f mapping from n to c, let χ(f) denote the characteristic matrix of f, i.e. χ(f)ᵢₗ=1 if and only if t(i)=l. Using this, the feature matrix can be expressed as B=Aχ(M), where M is the initial labeling. As nodes are labeled based on the link structure of the graph, the feature vector of node i can change as the nodes forming the neighbor of node i are labeled to reflect the changes in the neighborhood and enable propagation of labels to nodes.

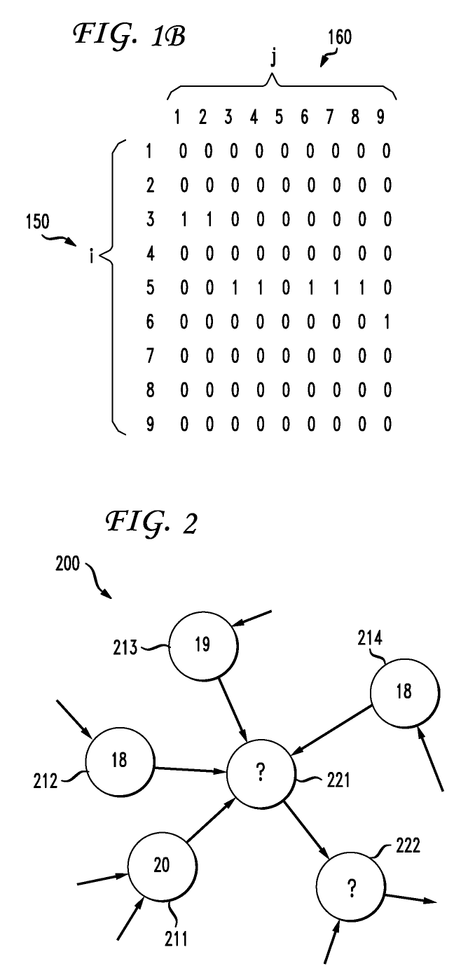

FIG. 2 shows a portion of a graph structure 200 that represents objects as nodes and the structural associations between the objects as edges. The graph structure 200 can include nodes 211-214 that have assigned or known labels and nodes 221 and 222 represent nodes with unassigned or unknown labels. The labels available for labeling are preferably selected from a predetermined set of labels. The nodes 221 and 222 can be assigned labels using a local iterative algorithm

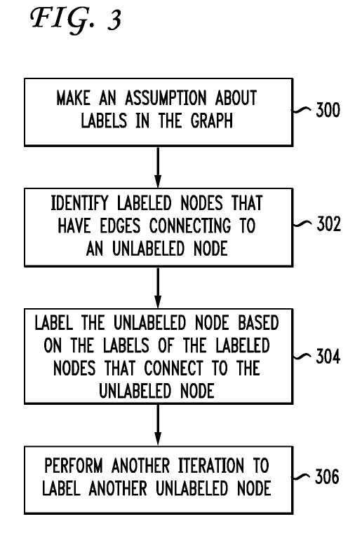

FIG. 3 is a flow diagram illustrating a high-level implementation of the local iterative approach with reference to the graph structure 200 of FIG. 2. Since the information available is limited and only some of the nodes are labeled, an assumption is made about how the nodes attain their labels (step 300). In a preferred embodiment, it is assumed that homophily exists. That is, edges are formed between similar nodes so that the label of a node is a function of the labels of adjacent nodes (i.e. nodes connect to other nodes with similar labels). The nodes 211-214 with known labels that have edges connecting to the node 221 with an unknown label are identified (step 302). The node 221 is labeled based on the labels of the nodes 211-214 that connect to the node 221 (step 304).

Once the node 221 is labeled, the local iterative method is used to assign a label for the node 222 (step 306). Thus, the local iterative algorithm enables using the edges between the nodes to provide a structural association from which nodes with unknown labels can be labeled. In addition, labels assigned to nodes may change during the iterations as a result of label changes to nodes adjacent to the labeled nodes. By allowing labels of formerly unassigned nodes to change, the preferred embodiments can improve the accuracy of the classification by responding to label information as it becomes available. This can ensure that classification of the nodes of interest is appropriate.

In one embodiment, a plurality voting scheme is used to infer the label. For example, each of the incoming edges connecting the adjacent nodes 211-214 to the node 221 can represent one vote. In this case, the nodes 212 and 214 vote for the label 18, while the node 211 votes for the label 20 and the node 213 votes for the label 19. As a result, the label, 18, which has the most votes, is assigned to the node 221. Other embodiments can implement voting schemes that use, for example, a median or average label drawn from an ordered domain.

In another embodiment, a voting scheme is used that assigns a voting weight based on a type of edge or a number of edges connecting one node to another. For example, the voting weight may be proportional to the number of edges connecting one node to another so that, for example, a node having two edges that connect to an unassigned node receives two votes. Those skilled in the art will recognize that various schemes can be implemented for inferring labels from adjacent node and that the voting schemes described herein are illustrative and not intended to be limiting.

The local iterative approach can be formally defined using adjacency matrix notation, where the matrix A is the adjacency matrix representation of the graph. At each iteration, a new labeling function M^{t} is computed such that for every unlabeled node i(i ε U, where U represents the unlabeled nodes in the graph), a label is assigned to M(i) based on voting by its neighbors. To label the nodes, at iteration t, M^{t} is defined by:

M^{t}(i)→voting(B₍ᵢ₎^{t}) where voting performs a function, such as plurality voting and B^{t} is the feature matrix for the t-th iteration, defined as follows:
DEFINITION 2. Let M^{t}:V→L ∪ {0} denote the labeling function on the t-th iteration (insisting that M^{t}(i)=M(i) for i ε W). Let conf^{t}:V→R be a function from nodes denoting the relative confidence that the labeling at the t-th iteration is accurate, where R represent real numbers. Set M⁰=M and conf⁰(i)=1 for all i ε W, zero otherwise. Let decay: N→R be a function which returns a weighting for labels assigned previously, where N represents integers. The iterative feature vector at iteration t, B^{t} can be defined as:

$${B}^{t} = A {\sum }_{{t}^{′} = 0}^{t - 1} decay ( t - {t}^{′} ) χ ( {M}^{{t}^{′}} ) diag ( {conf}^{ {t}^{′}} ) . \qquad ( 1 )$$

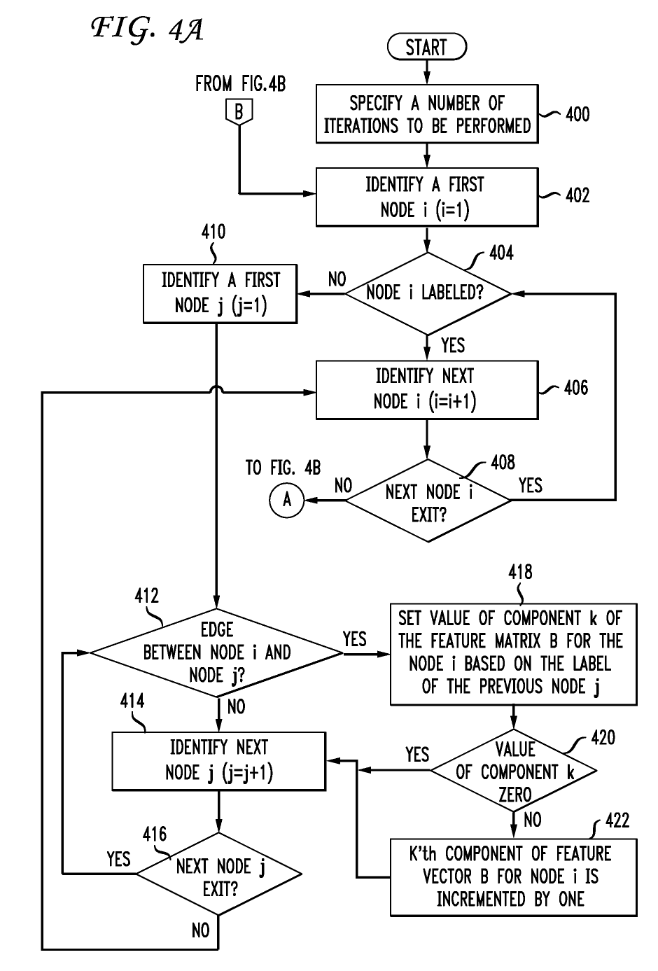

FIGS. 4A-B depict a flow diagram illustrating the labeling performed by a preferred embodiment of the local iterative approach. To simplify the discussion, an equal confidence is assigned for the iterations and an equal weighting is assigned for the labeling. However, those skilled in the art will recognize that different and/or varying confidences and weighting can be assigned. The feature vector B is initialized to zero and the initial labeling function M⁰ is defined (step 400). A number of iterations s performed by the local iterative approach can be specified (step 402). The local iterative method identifies a first node i (i=1) in the adjacency matrix A (step 404) and determines if the first node is an unlabeled node (i ε U) (step 406). If the first node (i=1) is labeled (step 406), the local iterative approach identifies next node (i=i+1), as long as the next node i exists (step 408), and determines if the node is labeled (step 404). When it is determined that a node i is unlabeled (step 404), the local iterative approach identifies a first node i (j=1) (step 410). If there is no edge between the first node j and the node i (step 412), the next node j (j=j+1) is identified (step 414), as long as the next node j exists (step 416). If the next node j does not exist (step 416, the local iterative approach continues to step 406. If the next node j does exist (step 416), the local iterative approach determines if there is an edge between the next node j and the node i (step 412). When it is determined there is an edge between the nodes i and j (step 412), the local iterative approach sets the value of component k of the feature vector B that corresponds to the node i based on the label associated with the previous node j (k=M^{t-1}(j)) (step 418) and begins to build a feature vector B for node i. Subsequently, the local iterative approach determines whether the value of the component k is zero (step 420). If k is zero (step 420), the next node j is identified (step 414). Otherwise, the k'th component of feature vector B for node i is incremented by one (B^{t}ᵢₖ=B^{t}ᵢₖ+1) (step 422), and the process continues with step 414. Once the feature vector B is created for nodes i that are unlabeled (steps 400-422), the local iterative method continues at step 424.

In step 424, the local iterative approach identifies the first node j=1). If the node j has a label (step 426), the local iterative approach ensures that the node j maintains that label by assigning the labeling function M(j) to the current labeling function of the iteration M^{t}(j) (step 428). If the node j does not have a label (step 426), the local iterative approach assigns a result the voting function performed on the feature vector B of the node j for the current iteration to the current labeling function M^{t}(j) (i.e. Mt(j) [symbol] voting(B^{t}(j)) (step 430). After either step 428 or 430, the local iterative approach identifies the next node j (j=j+1) (step 432). If the next node j exists (step 434), the process loops to step 426. Otherwise, the feature vector B^{t} of the current iteration t is assigned to the feature vector B^{t+1} for the next iteration (step 436). Subsequently if the number of iteration performed t is greater than the number of iterations specified s (step 438), the process ends. Otherwise, the process loops to step 402.

The time required to perform an iteration using the local iterative approach is generally based on the number of nodes |V| and edges |E| in the graph such that the time to perform an iteration can be expressed as the sum of the |V| and |E|. While the preferred embodiments of the local iterative method are described herein, those skilled in the art will recognize that other implementations of the local iterative method can be used to label unlabeled nodes in a graph based on edges and adjacent nodes.

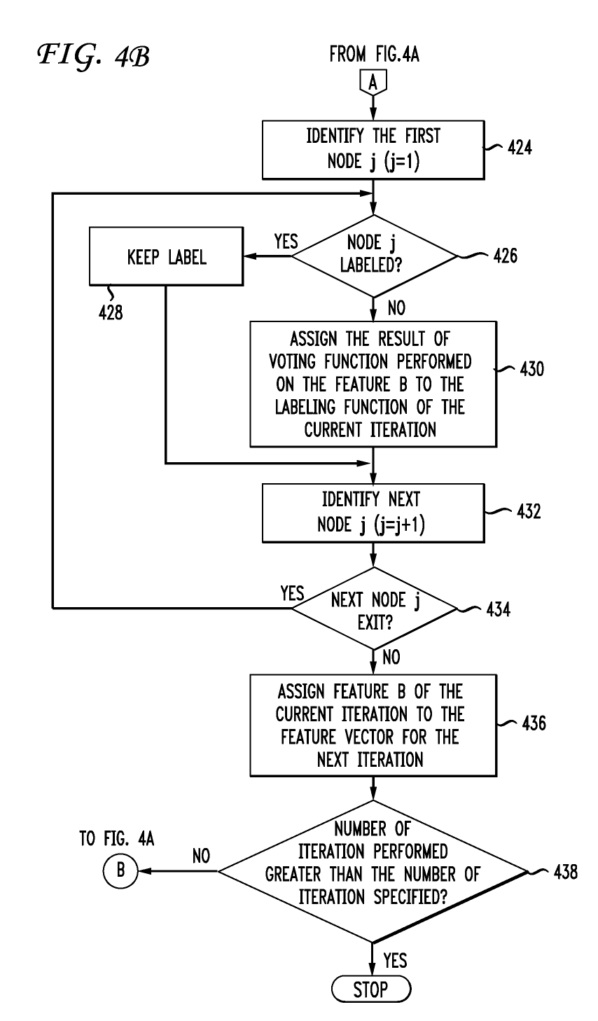

FIG. 5 shows a portion of a graph structure 500 that includes different types of nodes, such as blogs and web pages. The graph 500 can include nodes 511-515, which can represent a first type of node, and a node 521, which can represent a second type of node. The nodes 511-514 have assigned or known labels chosen from a predetermined set of labels. The node 515 has an unassigned or unknown label. Since the node 521 represents a different type of node from the nodes 511-515, the node 421 may not fit into the labeling scheme being applied. That is, no label from the predetermined set of labels may be suitable for characterizing the node 521. The nodes 511, 512, 514, and 521 are connected to the node 515 with edges, and therefore are considered to be adjacent nodes. The node 513 connects to the node 521 and is not adjacent to the node 515.

To prevent nodes from being isolated from other like nodes by nodes of a different type, the preferred embodiments of the present invention allow pseudo labels to be assigned to nodes of a different type. A pseudo label, as used herein, refers to a label that is assigned to a node of a different type than the nodes that are to be classified. Using pseudo labels can increase the number of nodes that are labeled in the graph and can increase the accuracy of the classification by allowing each adjacent node, whether of the same type or a different type, to be used when assigning a label for a node. Instead of omitting such nodes of a different type, pseudo-labels to allocate labels to nodes using an iterative approach even if these labels are not wholly meaningful classification of a node of a different type. As a result, labels can be propagated through a graph structure that includes different node types to ensure that nodes of interest receive meaningful labels and that the classification is accurate and complete.

For example, still referring to FIG. 5, the node 521, although of a different type, receives a pseudo label based on adjacent node 513, which has an edge connecting to the node 521. Thus, a pseudo label can be inferred for the node 521 based on the label of the 513 using the local iterative algorithm discussed above with respect to FIGS. 3 and 4. Once the node 521 is assigned the pseudo label, another iteration of the local iterative algorithm can be preformed and the node 515 can be assigned a label based on the labels of the adjacent nodes 511-514 and 521.

In another embodiment, a global nearest neighbor algorithm can be implemented to assign labels to unlabeled nodes. A set of labeled nodes around the unlabeled node (the neighborhood) are considered and the best match is used to assign the label. The global nearest neighbor approach assumes that nodes with similar neighborhoods have similar labels. Similar neighborhoods can be identified based on node interconnectivity. Node interconnectivity, as used herein, refers to connections between nodes in a neighborhood. As such, the matching is based on the similarity of the neighborhood (in terms of labels).

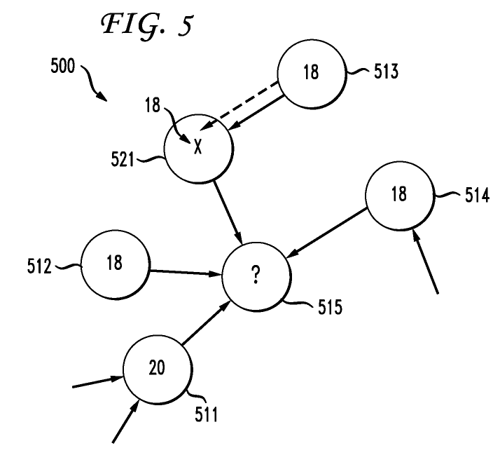

FIG. 6 shows a portion of a graph structure 600. The graph structure 600 can include nodes that represent objects and edges connecting the nodes. The edges represent a structural association between the nodes. The nodes 610 represent nodes that have known or assigned labels. The nodes 620 represent nodes that have unknown or unassigned labels. The labels available for labeling are from a known predetermined set of labels. The nodes 620 can be assigned labels based using the global nearest neighbor approach.

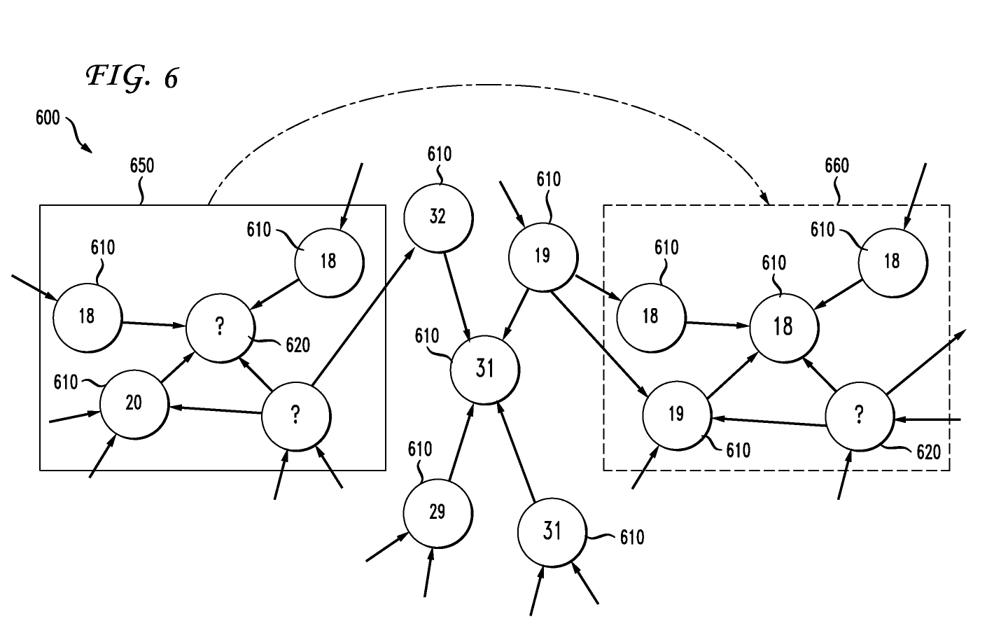

FIG. 7 is a flow diagram illustrating the global nearest neighbor approach and is discussed with reference to the graph structure 600 of FIG. 6. Since the information available is limited and only some of the nodes are labeled, an assumption is made about how the nodes attain their labels (step 700). In a preferred embodiment, it is assumed that nodes with similar neighborhoods have similar labels. Similar neighborhoods, therefore, can have similar node interconnectivity. The neighborhood 650 of nodes is identified that includes the node 620 (step 702). A similar neighborhood 660 is identified in which the unknown node is associated with a known node (step 704). A label is assigned to the node 620 based on the label of the node 610 in the neighborhood 660 (step 706).

The global nearest neighbor method can be performed in a single pass such that one or more nodes capable of being labeled are labeled. Thus, the global nearest neighbor algorithm enables using edges between the nodes to provide an explicit structure from which neighborhoods can be identified and nodes within one of the neighborhoods can be labeled based on nodes in the other neighborhood. In some embodiments, the global nearest neighbor approach may be performed iteratively.

The global nearest neighbor approach, can be described using the adjacency matrix notation discussed above, where the matrix A is an adjacency matrix of the graph structure 600. A feature vector B(i) representing the neighborhood of node i is constructed. The feature matrix B(i) is preferably an n by c (n×c) vector where n is the number of nodes and c is the number of possible labels. The feature vector represents the frequency of labels on the nodes in the neighborhood. An n by n (n×n) similarity matrix can be created for nodes in the graph structure 600. A similarity coefficient Sᵢⱼ is preferably computed between the feature vector B(i) of the node i and the feature vector B(j) of the node j for labeled nodes 3. Node i is assigned the label of the node with the highest similarity coefficient. If many labeled nodes have substantially similar neighborhoods to the node i to be labeled, the most frequently occurring label can be used.

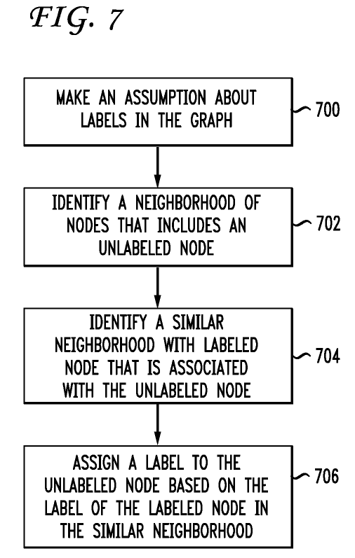

FIG. 8 is a flow diagram illustrating the global nearest neighbor approach in more detail. The feature vector B_{n×c}, the similarity matrix S_{n×n}, and the index i are initialized to zero (step 800). The number of edges in the set of edges Eᵢ can be represented as |E| such that i=(0, 1, 2, . . . |E|). The i^{th} edge Eᵢ represents an edge between node i and a node j and the original label of node j is assigned to a component k of the feature vector B for node i (step ( 802). If the value of k is not zero (step 804), the k^{th} component of feature vector B for node i is incremented by one (B^{t}ᵢₖ=B^{t}ᵢₖ+1) (step 806), and the process continues with step 808. Otherwise, the global nearest neighbor approach skips step 806 and goes directly to step 808.

At step 808, the global nearest neighbor approach preferably determines if the index i is greater than the number of edges |E|. If the index i does not exceed the number of edges |E| (step 808), the index i is incremented (step 809) and the process loops to step 802. Otherwise, the global nearest neighbor approach identifies a first node i (i=1) (step 810). If the node i is labeled (step 812), the next node i (i=i+1 is identified (step 814). If the node i is unlabeled (step 812), a first node j (j=1) is identified (step 816). Subsequently, the global nearest neighbor approach determines whether the node j is within a subset of nodes W in the set of nodes V (step 818). If node j is in the subset W (step 818), a similarity coefficient Sᵢⱼ between the feature vector B(i) of node i and the feature vector (B(j) of node j is computed (step 820) and the process continues with step 822. If the node j is not in the subset W (step 818), the next node (j=j+1) is identified (step 822). If the next node exists (j≦n) (step 824), the process loops to step 818. Otherwise, the process continues to step 826.

At step 826, the global nearest neighbor approach assigns the node i the most frequent label with the highest similarity coefficient. Subsequently, the next node i (i=i+1) is identified (step 814), as long as the next node exists (step 828) and the process loops to step 812. Otherwise the process stops.

The choice of similarity function to generate a similarity coefficient from the feature vectors is important. For example, given two vectors x and y, there are many possible choices, such as the Lₚ distances: Euclidean distance, ∥x-y∥₂, and Manhattan distance, ∥x-y∥₁. One choice for is the Pearson's correlation coefficient. The correlation coefficient is preferred over Euclidean distance when the shape of the vectors being compared is more important than the magnitude. For vectors x and y of dimension n, the correlation coefficient C is defined as:

$$C ( x , y ) = \frac{nx \cdot y - {‖ x ‖}_{1} {‖ y ‖}_{1}}{\sqrt{n {‖ x ‖}_{2}^{2} - {‖ x ‖}_{1}^{2} \sqrt{n {‖ y ‖}_{2}^{2} - {‖ y ‖}_{1}^{2}}}} . \qquad ( 2 )$$

In the multigraph case, different nodes, edges, and features F (V⁺, E⁺, F) can be taken into account by keeping the algorithm fixed and applying appropriate generalizations of the similarity function. For set valued features, sets X and Y can be compared using measures, such as Jaccard coefficient:

$$( J ( X , Y ) = \frac{\vert X ⋂ Y \vert}{\vert X ⋃ Y \vert} ) \qquad ( 3 )$$

The similarity function can combine the similarities of the features. For example, a weighted combination of Jaccard cofficients (for features represented as sets) and correlation coefficient (for vector features) can be implemented.

The time required to perform labeling using the global nearest neighbor is based on the number of unlabeled nodes |U|, subset of nodes |W|, labels |L|, and edges |E| such that the time required can generally be expressed as the sum of |E| and the product of |U|, |W|, and |L|. This assumes an exhaustive comparison of the possible pair of labeled nodes with unlabeled nodes. For appropriate similarity functions, this can be accelerated using dimensionality reduction and approximate nearest neighbors algorithms so that the label of a node that is approximately the nearest neighbor is found.

Generally, the global nearest neighbor approach performs a single pass and attempts to assign a label to unlabeled nodes based on the initially labeled nodes in the neighborhoods. However, those skilled in the art will recognize an iterative approach can be implemented with the global nearest neighbor approach so that conclusions on labels (and confidences) defined in the previous iteration are used in subsequent iterations.

As with the local iterative approach, the global nearest neighbor approach can incorporate nodes of a different type. Nodes with different types can be used when determining a similarity between neighborhoods. By allowing the global nearest neighbor approach to incorporate nodes of different types the accuracy of the classification can be increased. As a result, labels can be assigned based on a graph structure that includes different node types to ensure that nodes of interest receive meaningful labels and that the classification is accurate and complete.

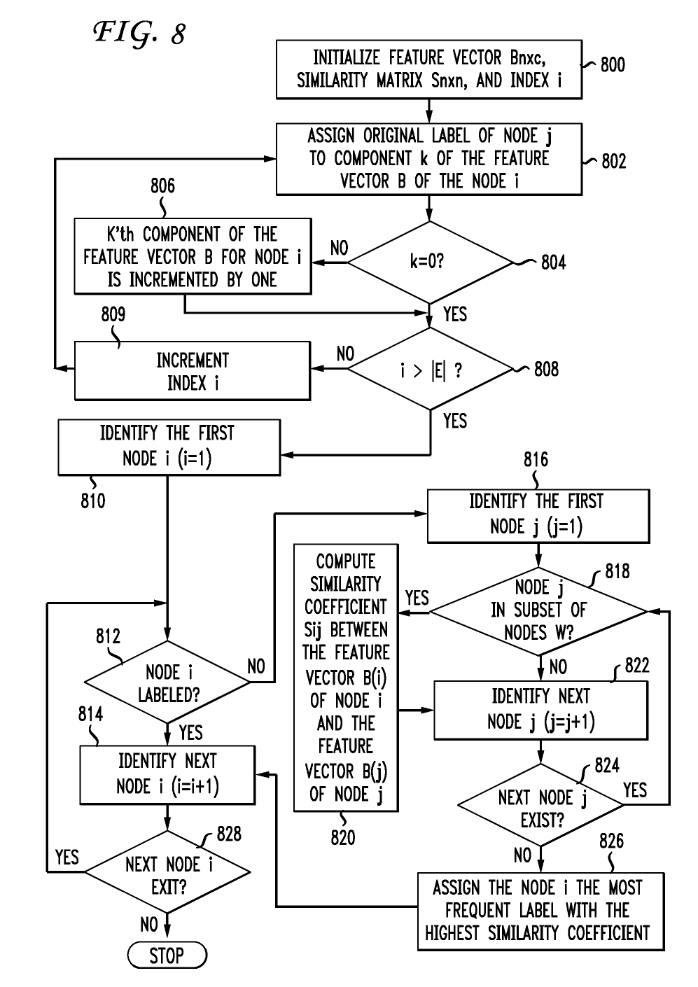

For example, referring to FIG. 9, a neighborhood 902 that includes an unlabeled node 910 can incorporate nodes 920 that have a different type than the node 910. The neighborhood 902 can be compared to a similar neighborhood 904 that also incorporates the nodes 920. A label can be assigned to the unlabeled node 910 based on the similarity of the neighborhoods.

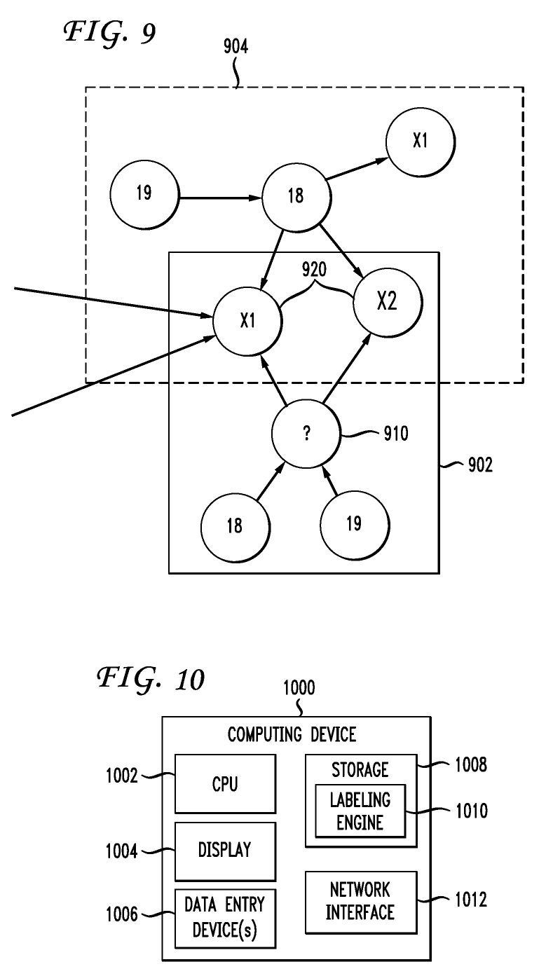

FIG. 10 shows a computing device for implementing the labeling of unlabeled nodes in a graph structure using the local iterative and/or global nearest neighbor algorithms. With reference to FIG. 10, a computing device 1000 can be, for example, a mainframe, personal computer (PC), laptop computer, workstation, PDA, or the like. In the illustrated embodiment, the computing device 1000 includes at least one central processing unit (CPU) 1002 and a display device 1004. The display device 1004 enables the computing device 1000 to communicate directly with a user through a visual display. The computing device 1000 can farther include data entry device(s) 1006, such as a keyboard, touch screen, and,or mouse. The computing device 1000 can include storage 1008 for storing data and instructions. The storage 1008 can include such technologies as a floppy drive, hard drive, tape drive, Flash drive, optical drive, read only memory (ROM), random access memory (RAM), and the like.

Applications, such as a labeling engine 1010 for implementing the local iterative and/or the global nearest neighbor approaches, as described above, can be resident in the storage 1008. The storage 1008 can be local or remote to the computing device 1000. The computing device 1000 preferably includes a network interface 1012 for communicating with a network formed by, for example, the Internet or an intranet. The CPU 1002 operates to run the application in storage 1008 by performing instructions therein and storing data resulting from the performed instructions, which may be presented to the user via the display 1004. The data can include a graph structure that includes nodes and edges that represents objects and an explicit structure between the objects, labeled and unlabeled nodes, results from classifying the nodes based on the explicit structure of the graph, or the like.

In an exemplary implementation, the preferred embodiments can be applied to classifying blogs. A blog, as used herein, refers to a web-based personal journal in which the entries (posts) are typically displayed in a reverse chronological order. Blog postings are made available for public viewing and a reader of the blog may provide immediate feedback by placing a comment to the original posting. Websites offer blog hosting with a variety of user interfaces and features. Blogs commonly include information about the owner/author in the form of a profile, in addition to the blog entries themselves.

When a user opens an account at a blog hosting site, the user may be asked to fill out a user profile form, where the user is usually asked to provide age, gender, occupation, location, interests (favorite music, books, movies, etc.), and the like. In some cases, the user can also provide an e-mail address, URL of a personal website, Instant Messenger ID's, etc. Most of this information is optional. Some services only reveal some information to a set of “friends” (accounts on the same service). This list of friends may be visible to all.

The blog owner can post blog entries which contain text, images, links to other websites and multimedia, and the like. The entries are typically accompanied by tie date and time each entry was made. Blog postings often reference other blogs and websites. Bloggers can also utilize special blog sections to display links of particular interest to them, such as “friends,” “links,“ ”subscriptions,” and the like.

There are many ways to extract a graph from a collection of blog data. Blogs can be encoded from graph nodes so that postings within a single blog can constitute a single node. Alternatively, blogs can be encoded as graph nodes at several granularities. For example, blog postings and comments can be treated as separate nodes. Additional nodes can represent webpages connected to blogs.

Web links can define edges in the blog graph. For example, a directed edge in the blog graph can correspond to a link from the blog to another blog or website. These links can be characterized according to where they appear within the blog pages. For example, links can appear in a blog entry, a comment posted as a response to a blog entry, in the “friends” category of the blog roll, and the like. The links can define various sets of edges, such as, explicit friend links, links to blogs, and links from blogs to websites.

In this example, labels can be based on components of the user profile. Such labels can cover a broad set of different label types (binary, categorical, continuous). Some examples of categories of labels can include, but are not limited to age, gender, and location. Blog profiles typically invite the user to specify their date of birth, and a derived age is shown to viewers. But the “age” attached to a blog can have multiple interpretations: the actual age of the blog author, the “assumed” age of the author, the age of the audience, and so on. Gender is another natural profile entry that can be used for labels. As with age, gender can also have multiple interpretations, such as the actual gender of the blog author, the “assumed” gender of the author, the gender of the audience, and so on. The stated location of the author is generally specified in some blogs. The location can be specified at granularities, such as continent (category with seven values) or country (category with over two hundred possible values).

A collection of blogs and the links between them can be represented with a graph structure, as discussed above, which can include a set of nodes that represent the blogs and a set of edges that represent the links. The links provide an explicit structure between the blogs, as well as other types of objects, such as web pages. An edge between nodes representing blogs can correspond to a reference from one blog to another blog. An edge between nodes of different types can correspond to a reference between blogs and web pages.

When working with age labels, it is assumed that bloggers tend to link to other bloggers of their own age for the local iterative approach and that boggers of the same age link to bloggers of similar age distributions for the global nearest neighbor approach. The initial feature matrix, B_{n×120}, can encode, for each node, the frequency of adjacent age labels. Because age is a continuous attribute, some smoothing by convolution of each feature vector with a triangular kernel can be incorporated, which can improve the quality of results.

For the location label, it is assumed for the local iterative approach that bloggers tend to link to other bloggers in their vicinity and, for the global nearest neighbor approach, that bloggers in the same locale link to similar distributions of locations.

A variety of weighting schemes can be implemented for edges to reflect the relative importance attached to friend links versus other links to blogs and web pages.

In addition to nodes corresponding to blogs, additional node types can be included, such as those corresponding to (non-blog) websites. These non-blog websites can be helpful in propagating labels, as described above. The non-blog websites are initially unlabeled and the local iterative approach, for example, can be used to assign a pseudo-label to these non-blog websites. Although some labels, such as Location or Age, seem inapplicable to webpages, it is possible to interpret them as a function of the location and age of the bloggers linking to the webpage.

The global nearest neighbor approach takes a different approach to using the different node types (e.g., non-blog websites). Since non-blog websites are initially not labeled, these websites play no part in a single pass of the global nearest neighbor algorithm. The similarity function between two nodes is extended as a weighted sum of the (set) similarity between neighborhoods and vector similarity between neighborhoods. In this case, for unlabeled nodes i and labeled nodes j in the subset of nodes W, the similarity coefficient is:

Sᵢⱼ=α×C(B₍ᵢ₎,B₍ⱼ₎)+(1−α)×J(V_{W(i)}, V_{W(j)}),

for α between zero and one, where B₍ᵢ₎ is the feature vector of the node i and V_{w(i)} is the set of web nodes linked to the blog node i.

Using a method in accordance with the present invention, data was collected by crawling three blog hosting sites: Blogger (www.blogger.com), LiveJournal (www.livejournal.com) and Xanga (www.xanga.com). The data consists of two main categories: user profiles containing personal information provided by the user, and blog pages containing the most recent (“front page”) entries for each crawled blog, as well as some archived entries. The structure of the derived blog graphs can differ due to data collection techniques. The collected data set consists of blogs from each of the three crawled sites, corresponding profiles, and extracted links between blogs and to webpages. For links to webpages, only the domain name of the web-page link is considered (so links to http://www.cnn.com/WEATHER/ and http://www.cnn.com/US/ are reduced to wvww.cnn.com). This improves the connectivity of the induced graph. The results for the number of user profiles collected and the number of links extracted are shown in Table 1.

TABLE 1

| | Blogger | LiveJournal | Xanga |
|---|---|---|---|
| Blog Nodes | 453K | 293K | 784K |
| Blog Edges | 534K | 411K | 2,997K |
| Web Nodes | 990K | 289K | 74K |
| Web Edges | 2,858K | 1,089K | 895K |
| Friend Edges | — | 3,977K | 64K |
| Age Labels | 47K | 124K | 493K |
| Gender Labels | 113K | | 580K |
| Location Labels | 111K | 242K | 430K |

The local iterative approach and/or the global nearest neighbor approach were performed on the blog data. In the experiments, the blog nodes are labeled with one of the three kinds of labels: continuous (age), binary (gender), nominal (location) of which the results of the continuous (age) labeling is discussed herein. The multigraph is also varied by the above weights on blog links (EB), friend links (EF), and web links (EW). For the local iterative approach, the number of iterations, s, is set to five, and the voting function to plurality voting. For the global nearest neighbor approach, the correlation coefficient is used as the similarity function, with α=0.5 when including web nodes as features. In the experimental settings, 10-fold cross validation is performed, and the average scores over the 10 runs is reported. The labeled set is divided into 10 subsets and evaluation is performed on each subset using the remaining 9 for training. Across the experiments, the results were highly consistent. The standard deviation was less than 2% in each case.

FIG. 11 summarizes the various experiments performed while labeling the blog nodes with ages 1 to 120, which are evaluated against the stated age in the blog profile. The features used by the two approaches are derived from the labels on a training set. With this information alone it is possible to obtain an accurate labeling.

FIG. 11A shows the performance of the local iterative approach for different acceptable errors from accurate prediction to five years off the reported age. The predictions for LiveJournal and Blogger show that with label data alone, it is possible to label with accuracy about 60% and 50%, respectively, within 3 years difference of the reported age. For the Xanga dataset, which is the most densely connected, the results are appreciably stronger: 88% prediction accuracy within 2 years off the reported age. FIG. 11B shows a similar plot for the global nearest neighbor approach. The prediction accuracy is similar between the approaches.

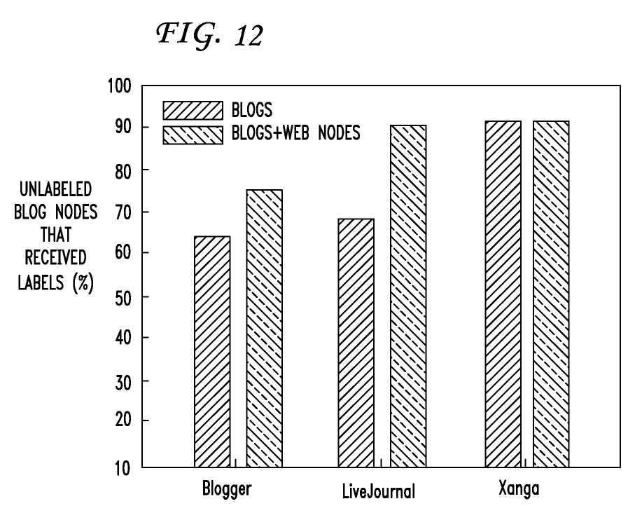

Using pseudo-labels for non-blog websites allowed for propagation of labels to nodes that would otherwise not receive labels. FIG. 12 shows a graph that shows a comparison between the number of unlabeled nodes that receive labels when only blogs are considered and when blogs and non-blogs are considered. As shown in FIG. 12, the number of unlabeled nodes that receive labels increases when pseudo-labeling is used for nodes of different types.

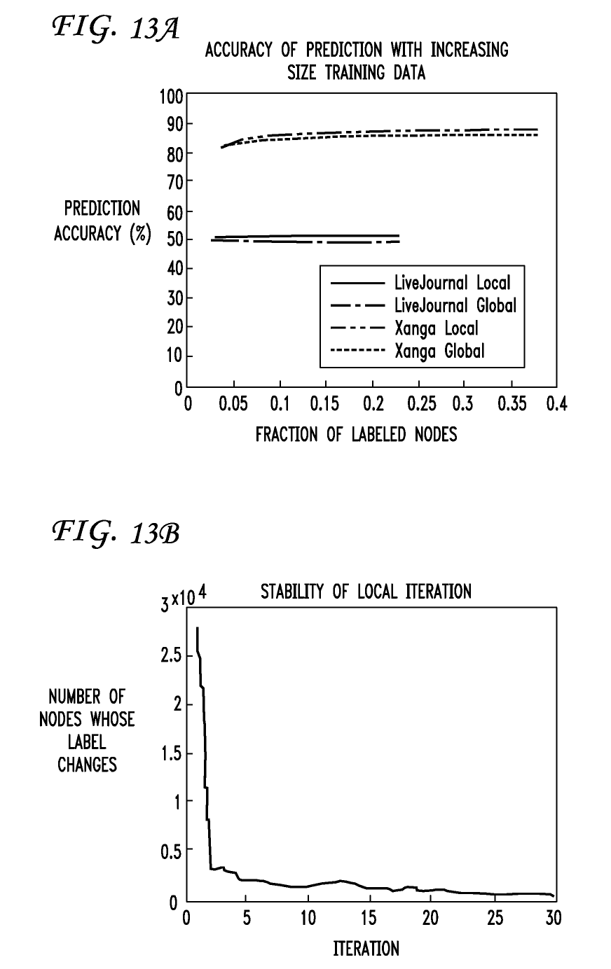

The above approaches work well even when only a small number of nodes in the graph have assigned or known labels. FIG. 13A illustrates that the performance of the two approaches does not change significantly as the percentage of unlabeled data used for training is verified, even when the total number of initially labeled nodes is below 1%. The number of nodes for which the label changes during an iteration of the local method sharply declines in the first iteration (from the 30K initial nodes), followed by a rapid decay as shown in FIG. 13B. The graph shown is for the Blogger dataset over the age label. Small changes persist over multiple iterations as the local neighborhood of a node changes slightly, but do not impact accuracy. Each of the experiments used five iterations.

While preferred embodiments of the present invention have been described herein, it is expressly noted that the present invention is not limited to these embodiments, but rather the intention is that additions and modifications to what is expressly described herein are also included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

What is claimed is:

1. A method of determining information associated with an object represented as a node in a graph comprising:
associating a label of at least one labeled node with an unlabeled node based on a structural association between the unlabeled node and the labeled node.

2. The method of claim 1, wherein associating the label comprises associating the label of the at least one labeled node with the unlabeled node using a local iterative approach.

3. The method of claim 2, wherein associating the label comprises determining a frequency at which the label occurs based on a connection between the unlabeled node and the labeled node.

4. The method of claim 2, wherein the graph comprises a node of a type different than that of the unlabeled node, the method further comprising associating a pseudo-label with the node of the different type.

5. The method of claim 4, wherein the node of the different type is structurally associated with the unlabeled node, the associating of the label being based on the structural association between the node of the different type and the unlabeled node.

6. The method of claim 2, wherein the label associated with the unlabeled node changes during an iteration of the local iterative approach.

7. The method of claim 1, wherein associating the label comprises associating the label of the at least one labeled node with the unlabeled node using a global nearest neighbor approach.

8. The method of claim 7, wherein the structural association comprises a similarity between a node interconnectivity of a first neighborhood of the unlabeled node and a node interconnectivity of a second neighborhood associated with the labeled node.

9. A computer-readable medium comprising instructions executable by a computing device for determining information associated with an object represented as a node in a graph by:
associating a label of at least one labeled node with an unlabeled node based on a structural association between the unlabeled node and the labeled node.

10. The medium of claim 9, wherein associating the label comprises associating the label of the at least one labeled node with the unlabeled node using a local iterative approach.

11. The medium of claim 10, wherein associating the label comprises determining a frequency at which the label occurs based on a connection between the unlabeled node and the labeled node.

12. The medium of claim 10, wherein the graph comprises a node of the type different than that of the unlabeled node, the medium further comprising associating a pseudo-label with the node of the different type.

13. The medium of claim 12, wherein the node of a different type is structurally associated with the unlabeled node, the associating of the label being based on the structural association between the node of the different type and the unlabeled node.

14. The medium of claim 10, wherein the label associated with the unlabeled node changes during an iteration of the local iterative approach.

15. The medium of claim 9, wherein associating the label comprises associating the label of the at least one labeled node with the unlabeled node using a global nearest neighbor approach.

16. The medium of claim 15, wherein the structural association comprises a similarity between a node interconnectivity of a first neighborhood of the unlabeled node and a node interconnectivity of a second neighborhood associated with the labeled node.

17. A system for inferring a label classification associated with an objected represented as a node in a graph:
a computing device configured to associate a label associated with at least one labeled node with at least one unlabeled node based on the structural association between the unlabeled node and the labeled node in the graph.

18. The system of claim 17, wherein the computing device performs at least one of a local iterative approach or a global nearest neighbor approach.

19. The system of claim 18, wherein the structural association is a similarity between a node interconnectivity of a first neighborhood of the unlabeled node and a node interconnectivity of a second neighborhood of the labeled node.

20. The system of claim 17, wherein the graph comprises a node of a different type compared to the unlabeled node for which a pseudo-label is assigned.
